(19) United States
(12) Patent Application Publication
(10) Pub. No.: US 2025/0285167 A1
(43) Pub. Date: Sep. 11, 2025

(54) COMPUTER IMPLEMENTED SYSTEMS, SOFTWARE, AND METHODS FOR PRODUCT SEARCHING INCLUDING LOCAL AND IN-STORE NAVIGATION INFORMATION

(71) Applicant: Andrew Nix, Port Charlotte, FL (US)

(72) Inventor: Andrew Nix, Port Charlotte, FL (US)

(21) Appl. No.: 18/599,744

(22) Filed: Mar. 8, 2024

(51) Int. Cl. G06Q 30/0601; G01C 21/36

(52) U.S. Cl. CPC G06Q 30/0639; G01C 21/3608

(57) ABSTRACT

A computing system and method are provided to locate and provide detailed navigation to products at local retailers. The system includes one or more hardware processors and associated memory configured by machine-readable instructions to: provide a product search feature configured to be accessed by a user; generate product search results, based upon a user product search request input to the product search feature, including an availability, inventory, price and store location, of a searched product; output the search results to a visual display for selection by the user; output to the visual display, based upon a chosen result of the product search results selected by the user, navigation information providing local navigation to the corresponding store location; and output to the visual display, based upon the chosen result, in-store location identifying details providing in-store navigation to the corresponding in-store product location.

### FIELD OF THE INVENTION

The present invention relates to systems, software applications, and methods for computer networks and mobile devices, and more specifically mobile applications for searching, and navigating to, products.

### BACKGROUND

Mobile applications for product searching have become an integral part of the modern shopping experience. These apps have revolutionized the way consumers find and purchase products by leveraging the power of smartphones, internet connectivity, and advanced technologies. The rise of e-commerce platforms and online shopping has fundamentally changed consumer behavior. Shoppers increasingly turn to digital platforms to explore, compare, and purchase products. Mobile apps have become an essential channel for accessing e-commerce websites.

Mobile apps offer unparalleled convenience and accessibility. Users can search for products anytime, anywhere, directly from their smartphones. This level of accessibility has reshaped how consumers engage with brands and retailers. Mobile apps provide a user-friendly interface for product discovery and exploration. Users can browse through vast catalogs of products, view images, read descriptions, and access reviews and ratings. These features facilitate informed purchasing decisions.

Many product searching apps offer barcode and image recognition technology. Users can scan barcodes or take pictures of products to quickly access information such as prices, reviews, and availability. This streamlines the shopping process. Location-based services integrated into mobile apps enable users to find nearby stores and products. This is particularly useful for consumers looking for real-time, in-store shopping experiences.

Mobile apps often include price comparison tools, allowing users to find the best deals and discounts across different retailers. This encourages price-conscious shopping. Personalization algorithms in these apps analyze user behavior and preferences to provide tailored product recommendations. This enhances the user experience and increases the likelihood of successful conversions.

Some advanced product searching apps utilize AR and VR technologies. Users can virtually try on clothing and accessories, visualize furniture in their homes, or experience products in immersive ways before making a purchase. Social media and mobile commerce have become closely intertwined. Many product searching apps integrate with social media platforms, allowing users to discover products recommended by friends, influencers, or through sponsored content.

The proliferation of mobile apps for product searching has forced retailers and brands to enhance their online presence and optimize their product listings. It has also increased competition, driving innovation and improved customer experiences. These apps generate a wealth of data on user preferences, shopping habits, and trends. Retailers and brands can leverage this data to refine their marketing strategies and tailor their product offerings.

In conclusion, mobile applications for product searching have reshaped the retail landscape, offering consumers unprecedented convenience and retailers new ways to connect with their customers. As technology continues to evolve, these apps will continue to play a central role in how people discover and purchase products in an increasingly digital world.

There is still a need for systems, software applications, and methods that can enhance the user experience when searching for products nearby.

### SUMMARY

The present application discloses embodiments including and/or related to systems, methods, and apparatus that deliver improvements in computer-implemented technology by providing product search and navigation capabilities that enhance the user experience.

In a first aspect, a computing system is provided to locate and provide detailed navigation to products at local retailers. The system includes one or more hardware processors and associated memory configured by machine-readable instructions to: provide a product search feature configured to be accessed by a user; generate product search results, based upon a user product search request input to the product search feature, including an availability, inventory, price and store location, of a searched product; output the search results to a visual display for selection by the user; output to the visual display, based upon a chosen result of the product search results selected by the user, navigation information providing local navigation to the corresponding store location; and output to the visual display, based upon the chosen result, in-store location identifying details providing in-store navigation to the corresponding in-store product location.

Additionally and/or alternatively, providing the product search feature includes outputting a graphical user interface (GUI), including a product search field.

Additionally and/or alternatively, providing the product search feature comprises providing a voice-activated product search feature.

Additionally and/or alternatively, the user product search request input to the product search feature includes at least one of keywords, barcodes, and QR codes.

Additionally and/or alternatively, the visual display comprises at least one of a visual display unit, Augmented Reality (AR) smart glasses, and an image projector.

Additionally and/or alternatively, the navigation information includes at least one of turn-by-turn directions and map guidance to guide the user to the corresponding store location.

Additionally and/or alternatively, the in-store location identifying details includes at least one of waypoints, turn-by-turn directions, and an interactive store map.

Another embodiment is directed to a method to locate and provide detailed navigation to products at local retailers, using one or more hardware processors and associated memory configured by machine-readable instructions. The method includes: providing a product search feature configured to be accessed by a user; generating product search results, based upon a user product search request input to the product search feature, including an availability, inventory, price and store location, of a searched product; outputting the search results to a visual display for selection by the user; outputting to the visual display, based upon a chosen result of the product search results selected by the user, navigation information providing local navigation to the corresponding store location; and outputting to the visual display, based upon the chosen result, in-store location identifying details providing in-store navigation to the corresponding in-store product location.

Additionally and/or alternatively, providing the product search feature includes outputting a graphical user interface (GUI), including a product search field.

Additionally and/or alternatively, providing the product search feature comprises providing a voice-activated product search feature.

Additionally and/or alternatively, the user product search request input to the product search feature includes at least one of keywords, barcodes, and QR codes.

Additionally and/or alternatively, the visual display comprises at least one of a visual display unit, Augmented Reality (AR) smart glasses, and an image projector.

Additionally and/or alternatively, the navigation information includes at least one of turn-by-turn directions and map guidance to guide the user to the corresponding store location.

Additionally and/or alternatively, the in-store location identifying details includes at least one of waypoints, turn-by-turn directions, and an interactive store map.

In a third aspect, a computer-readable memory is provided. The computer-readable memory has stored therein instructions executable by a processor to cause a computing system to perform functions. The functions include: providing a product search feature configured to be accessed by a user; generating product search results, based upon a user product search request input to the product search feature, including an availability, inventory, price and store location, of a searched product; outputting the search results to a visual display for selection by the user; outputting to the visual display, based upon a chosen result of the product search results selected by the user, navigation information providing local navigation to the corresponding store location; and outputting to the visual display, based upon the chosen result, in-store location identifying details providing in-store navigation to the corresponding in-store product location.

Additionally and/or alternatively, providing the product search feature includes outputting a graphical user interface (GUI), including a product search field.

Additionally and/or alternatively, providing the product search feature comprises providing a voice-activated product search feature.

Additionally and/or alternatively, the visual display comprises at least one of a visual display unit, Augmented Reality (AR) smart glasses, and an image projector.

Additionally and/or alternatively, the navigation information includes at least one of turn-by-turn directions and map guidance to guide the user to the corresponding store location.

Additionally and/or alternatively, the in-store location identifying details includes at least one of waypoints, turn-by-turn directions, and an interactive store map.

The embodiments provide an enterprise resource software application that digitally enhances the product search experience. The system and method provide a product search and navigation approach that improves results using local navigation and in-store navigation.

### BRIEF DESCRIPTION OF THE DRAWINGS

The figures which accompany the written portion of this specification illustrate embodiments and method(s) of use according to the teachings of the present invention.

FIG. 1 shows a schematic block diagram illustrating a communication system including product search and navigation capabilities on servers and mobile devices according to an embodiment of the present invention.

FIG. 2 is a schematic block diagram illustrating the components of a computing device (e.g. a mobile device) according to an embodiment of the present invention of FIG. 1.

FIGS. 3-7 are front views illustrating a user's mobile device displaying a Graphical User Interface (GUI) with various example screens regarding for the product search and navigation system and method according to an embodiment of the present invention of FIG. 1.

FIG. 8 is a block diagram of a computing system configured for providing the product search and navigation system and method, in accordance with the example embodiments.

FIG. 9 is a flow chart showing functions of a method for providing the product search and navigation capabilities, in accordance with the example embodiments.

All the figures are schematic, not necessarily to scale, and generally only show parts which are necessary to elucidate example embodiments, wherein other parts can be omitted or merely suggested.

The various embodiments of the present invention will hereinafter be described in conjunction with the appended drawings, wherein like designations denote like elements.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

Generally speaking, depending on the type of wireless communication system, a wireless communication device or mobile device, such as a smartphone, cellular telephone, two-way radio, personal digital assistant (PDA), personal computer (PC), laptop computer, ocular device, etc., communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel or channels. For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

The present embodiments are generally directed to a product search and navigation approach that improves results using local navigation and in-store navigation.

A mobile application is designed to locate products and inventory within a local area, and also within the store by providing users with efficient tools to navigate and find items. The app may leverage advanced technologies such as global positioning systems (GPS), indoor positioning, augmented reality, and beacon technology to guide users to their desired products, enhancing convenience and improving overall customer satisfaction.

Various key features may include product searching, geolocation, indoor positioning, interactive store maps, navigation and directions, beacon technology, and augmented reality (AR), for example. With product search, users can search for products using keywords, barcodes, or QR codes, for example. The app then provides real-time information on the product's availability, inventory, price, and store location, and detailed location within the store (e.g. aisle, bin, row, and/or other location identifying data). With geolocation, once a user selects a product, the app generates turn-by-turn directions and/or map guidance to guide the user to the store, providing optimal routes and choices. With indoor positioning, the application may utilize indoor positioning systems (IPS) to accurately determine a user's location within the store. IPS may rely on Wi-Fi, Bluetooth, magnetic fields, or sensor fusion, for example, to triangulate the user's position and guide them to the desired aisle or shelf.

With interactive store maps, the app may include an interactive store map that displays the layout of the store and indicates the locations of various products. Users can search for specific items and receive step-by-step directions to their destinations. With navigation and directions, the app generates turn-by-turn directions to guide the user through the store, providing optimal routes and highlighting points of interest (e.g., aisle, row, shelf etc.) along the way. With beacon technology, the application may leverage the placement of small devices (e.g. Bluetooth-enabled devices) throughout the store. These beacons communicate with the user's mobile device, delivering location-specific notifications, offers, and directions. With AR or an ocular device: AR-enabled apps overlay digital information onto the user's real-world view through their device's camera and/or display. Users can see virtual arrows or markers guiding them to their desired products, enhancing the visual navigation experience. Also, user reviews and ratings may be included, where the app may allow users to provide reviews and ratings for products, helping others make informed decisions and fostering a sense of community within the shopping experience.

Various benefits may include time efficiency, enhanced shopping experience, increased sales, customer engagement and accessibility, for example. With time efficiency, the mobile app for locating products and inventory reduces the time spent searching for items, leading to quicker shopping trips and improved customer satisfaction. With enhanced shopping experience, the app may offer a more interactive and engaging shopping experience by providing users with dynamic navigation and useful information. Customers would have ability to rate the retailer based on actual inventory, and check out without the use of the check-out line using their mobile wallet of choice. For increased sales, the app may help customers find products and inventory more easily, the app can contribute to increased sales as shoppers are more likely to make purchases when they can quickly locate items. With customer engagement, the integration of AR and beacon technology fosters customer engagement through personalized offers, promotions, and notifications. With accessibility, the app benefits all types of shoppers, including those with mobility challenges, by offering an accessible way to navigate large retail spaces.

Accordingly, the mobile application is designed for locating available products and inventory at a store within a local area, and within the store to enhance the shopping journey by utilizing indoor positioning, interactive maps, and innovative technologies like AR and beacons. The app will streamline the shopping process, improve customer satisfaction, and contribute to a more convenient and enjoyable retail experience.

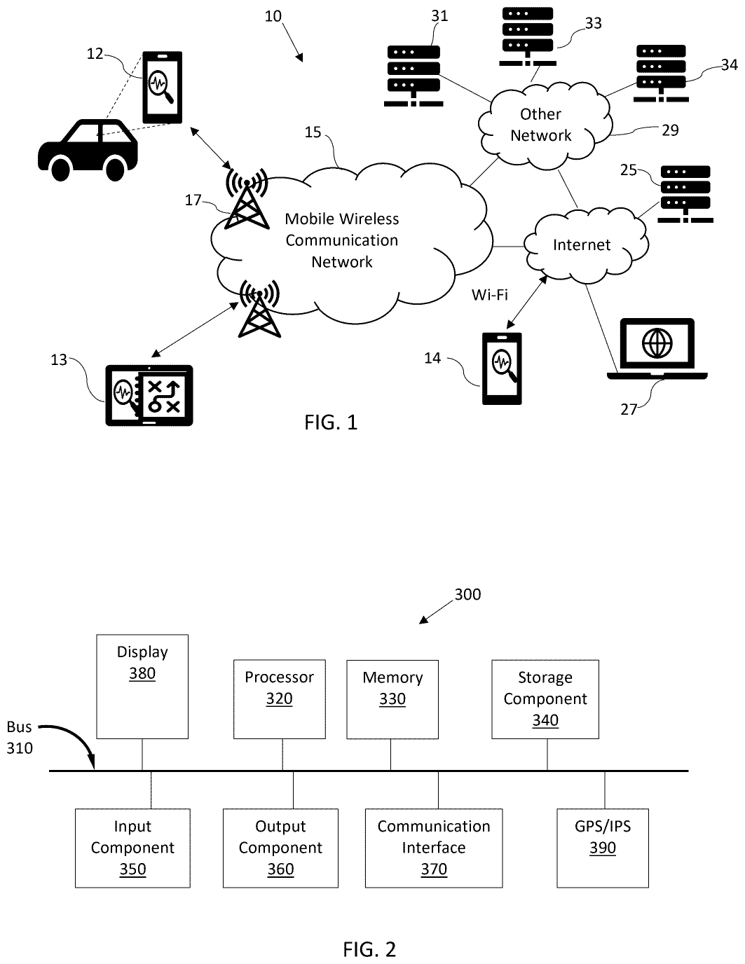

FIG. 1 illustrates a system 10 offering a product search and navigation services, including communications in support of providing product search and navigation communications for users' mobile devices. The example shows three mobile devices 12, 13, and 14 as well as a mobile wireless communication network 15. The devices 12-14 are examples of computing devices that may execute an application configured to provide the product search and navigation functionality. The network 15 provides mobile wireless communications services to those devices as well as to other mobile devices via several base stations 17. The present techniques may be implemented in any of a variety of available mobile networks 15 and/or on any type of mobile devices compatible with such a network 15.

Some mobile devices 12-14 may be operative to communicate using a variety of communication networks and protocols other than those used for communication through the mobile wireless network 15. For example, as shown for device 14, at least some mobile devices are additionally or alternatively configured for data communication through a wireless communication link such as a Wi-Fi link. Mobile devices communicating through Wi-Fi communication links may access Internet-connected servers and services directly through the Internet 23, and/or access servers and services provided by a carrier of the mobile wireless network 15 via the Internet 23 and a private network 29 operated by the carrier.

The wireless mobile communication network 15 may include one or more wired and/or wireless networks or connections. For example, network 15 may include a cellular network (e.g., a long-term evolution (LTE) network, a 5G network, or a code division multiple access (CDMA) network), a public land mobile network (PLMN), a local area network (LAN) (e.g., a Wi-Fi network), a wide area network (WAN), a metropolitan area network (MAN), a telephone network (e.g., the Public Switched Telephone Network (PSTN)), a private network, an ad hoc network, a wired connection, a wireless connection (e.g., a Bluetooth connection or a near field communication connection), IPS, or the like, and/or a combination of these or other types of networks or connections. IPS may accurately determine a user's location within the store. IPS may rely on Wi-Fi, Bluetooth, magnetic fields, or sensor fusion, for example

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

The mobile devices 12-14 are capable of data communications through the network 15, and some devices may additionally be capable of voice telephone communications through the network 15.

The network 15 typically offers a variety of data services via the Internet 23, such as downloads, web browsing, email, etc. As illustrated, there is shown a laptop PC type user terminal 27 as well as a server 25 connected to the Internet 23; and the data services for the mobile devices 12-14 via the Internet 23 may be with such devices or any other type of device or system capable of data communications through the various interconnected networks. Data services for the mobile devices 12-14 can additionally be routed directly to the Internet 23 through other types of communication links, such as Wi-Fi links, in situations in which the mobile devices 12-14 are configured for communications across and have access to such links. The mobile devices 12-14 of users can receive or download software applications through the networks 23 and/or 15, such as application and/or other applications, and execute the applications written in various programming languages.

Mobile devices 12-14 can be portable handsets, smartphones, or personal digital assistants, although they may be implemented in other forms. For example, mobile devices 12-14 can be tablet computers, such as iPads, or other computing devices such as ocular devices (e.g. headsets or heads-up displays) configured for communication through a mobile wireless communication network 15 and/or other types of wireless communication links. Program applications, including the present product search and navigation application, can be configured to execute on many different types of mobile devices 12-14. For example, a mobile device application can be written to execute on a Windows Mobile based mobile device, Android, iPhone, Java Mobile, or Blackberry based mobile device, for example.

The mobile communication network 15 can be implemented by a number of interconnected networks. Hence, the overall network 15 may include a number of radio access networks, as well as regional ground networks and a wide area network (WAN) interconnecting the regional ground networks to core network elements. Physical elements operated by one of the mobile service providers or carriers include a number of base stations represented in the example by the base stations 17. A base station 17 can include a base transceiver system, which can communicate via an antenna system at the site of the base station and over the air link with one or more of the mobile devices 12-14, when the mobile devices are within range. Each base station can be coupled to several antennas mounted on a radio tower within a coverage area. A base station 17 may be a part of an IPS system within a retail location, for example, a beacon.

The mobile devices 12-14 communicate over the air with a base station 17 and through the mobile wireless network 15 for various voice and data communications, e.g. services provided by an Internet-connected server 25 (e.g. a product search and navigation management server) and/or application servers 31, 33, 34. The product search and navigation management server may be defined by a single computer, server cluster and/or network appliance that is operated by a product search and navigation management company or any other industry related organization that handles product search and navigation management as would be appreciated by those skilled in the art.

Referring additionally to FIG. 2, an embodiment of a computing device 300, such as mobile devices 12-14 of FIG. 1, including a product search and navigation capability in accordance with features of the present invention will be described. FIG. 2 is a diagram of example components of a device 300. Device 300 may correspond to mobile device 12, 13 or 14. As shown in FIG. 2, device 300 may include a bus 310, a processor 320, a memory 330, a storage component 340, an input component 350, an output component 360, a communication interface 370, a display 380 and geolocation capabilities 390, such as Global Positioning System (GPS) and Indoor Positioning System connectivity and processing.

Bus 310 may include a component that permits communication among the components of device 300. Processor 320 is implemented in hardware, firmware, or a combination of hardware and software. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, processor 320 may include one or more processors capable of being programmed to perform a function. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include various computer memory types such as RAM, DRAM, SDRAM, DDR, GDDR, HBM, ROM, PROM, EPROM, EEPROM, NVRAM a hard disk (e.g., a magnetic disk, an optical disk, a magneto-optic disk, a solid state disk, etc.), a compact disc (CD), a digital versatile disc (DVD), a floppy disk, a cartridge, a magnetic tape, an SSD, and/or another type of non-transitory computer-readable medium, along with a corresponding drive.

Input component 350 may include a component that permits device 300 to receive information, such as via user input (e.g., components of a touch screen display, a keyboard, a keypad, a mouse, a button, a switch, a microphone, etc.). Additionally, or alternatively, input component 350 may include a sensor for sensing information (e.g., a geo-location module such as a global positioning system (GPS) component, an accelerometer, a gyroscope, an actuator, etc.). Output component 360 may include a component that provides output information from device 300 (e.g., a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, IPS interface, or the like.

Display 380 may be a digital display, for example, an LCD, LED, plasma display, touch screen, ocular device, projection display, or any other digital display capable of communicating information including displaying GUIs, images, video, etc. The display 380 may present 2D, 3D, and/or AR images to a user of the system and method.

GPS/IPS 390 is a navigation device, which may include a GPS receiver, or simply a GPS, and is capable of receiving information from Global Navigation Satellite Systems (GNSS) satellites and then calculating the device's geographical position. Using suitable software, the device 300 may display the position on a map, and it may offer routing directions. GPS/IPS 390 also provides geographical positioning information to the processor 320 for use in providing improved product navigation services. GPS/IPS 390 may also include an IPS capability which utilizes a network of devices used to locate people or objects where GPS and other satellite technologies lack precision or fail entirely, such as inside retail locations.

A large variety of techniques and devices are used to provide indoor positioning ranging from reconfigured devices already deployed such as smartphones, WiFi and Bluetooth antennas, digital cameras, and clocks; to purpose built installations with relays and beacons strategically placed throughout a defined space. Lights, radio waves, magnetic fields, acoustic signals, and behavioral analytics may all be used in IPS approaches. IPS may achieve position accuracy of 2 cm, for example.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 300 may include additional components, fewer components, different components, or differently arranged components than those shown in FIG. 2. Additionally, or alternatively, a set of components (e.g., one or more components) of device 300 may perform one or more functions described as being performed by another set of components of device 300.

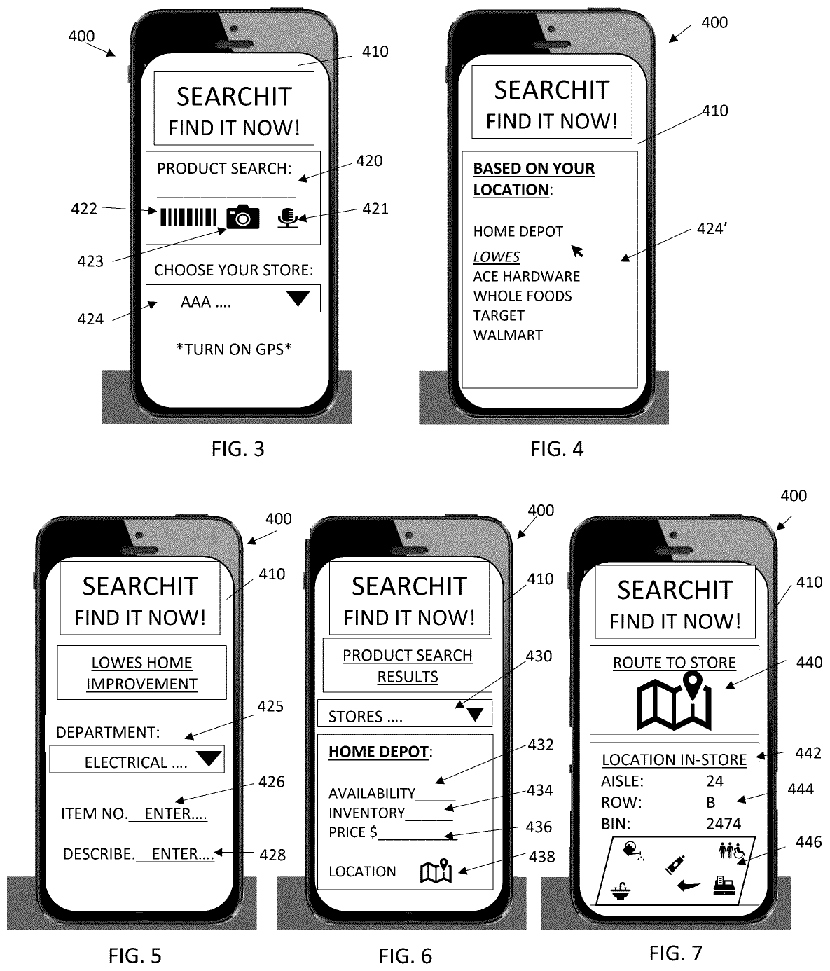

Referring additionally to FIGS. 3-7, there are shown front views of a smartphone 400, which may be an example of the mobile devices 12-14 of FIG. 1, and computing device 300 of FIG. 2. The smartphone 400 has installed thereon (e.g. in the memory 330 or storage component 340), a product search and navigation application (e.g. also referred to as a product search and navigation manager) that provides capabilities for a user to search for, and locate, product options that include specific navigation information on such a mobile device. The application includes instructions to be executed by the processor 320.

Execution of the instructions causes the processor 320 to: generate a graphical user interface (GUI) 410 on the display 380 that provides for product search capability and/or the selection of store options; control the mobile wireless communication interface 370 to connect to a product search server (e.g. server 25), via the wireless communication network 15, to interact, e.g. via GUI 410, therewith; and operate the display 380 to show product search field 420, store selection list (e.g. as a drop down menu 424 or a list 424′ based upon location of the user), department/category list 425, item search field 426, description search field 428, store results list 430, store availability 432, inventory 434, price 436 and location information 438, local navigation information 440, and in-store navigation information 442 (including product location data 444 and/or a product location map 446).

FIGS. 3-7 are front views illustrating a user's mobile device or smartphone 400 displaying the GUI with various example screens regarding product search results and navigation information according to an embodiment of the present invention. For example, FIG. 3 illustrates a GUI screen 410 with information and fields to perform a product search request for a user of the application. For example, the GUI screen 410 may include the product search field 420, and also includes voice activation feature 421, barcode scanning 422, and or QR code scanning 423 as illustrated.

FIG. 4 illustrates a GUI screen 410 of a corresponding a user's device 400 and includes a store selection list 424′ based upon location of the user. FIG. 5 illustrates another GUI screen 410 of a corresponding a user's device 400 and includes the department/category list 425, item search field 426, and description search field 428, for example. FIG. 6 illustrates a store results list 430 being displayed to a user's device 400 and requesting the user to select a store from a drop down menu, for example, while leading to the display of product search results including store availability 432, inventory 434, price 436 and location information 438, as illustrated. FIG. 7 illustrates the local navigation information 440 being displayed to the user which may include step-by-navigation or map route navigation, as would be appreciated by those skilled in the art. Also, in-store navigation information 442 is displayed which may include product location data 444 and/or a product location map 446, for example, as illustrated. The product location data may include details to locate and navigate precisely to the needed product at a local retailer, or local wholesaler, showing in-stock items with aisle, bin, row, or other location identifying marks, for example.

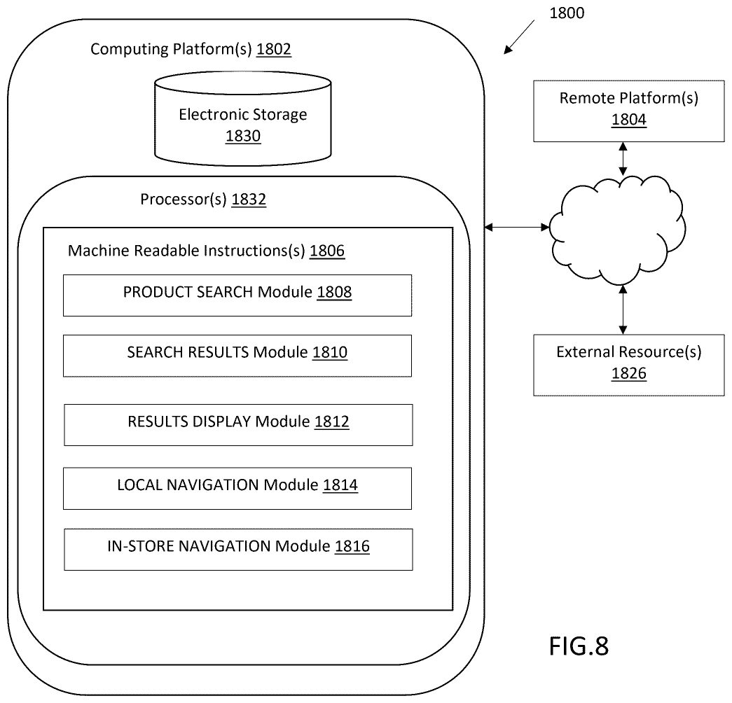

FIG. 8 is a block diagram of a computing system 1800 configured for providing the product search and navigation system and method, in accordance with the example embodiments. In some implementations, computing system 1800 can include one or more computing platforms 1802. Computing platform(s) 1802 can be configured to communicate with one or more remote platforms 1804 according to a client/server architecture, a peer-to-peer architecture, and/or other architectures. Remote platform(s) 1804 can be configured to communicate with other remote platforms via computing platform(s) 1802 and/or according to a client/server architecture, a peer-to-peer architecture, and/or other architectures. Users can access computing system 1800 via remote platform(s) 1804. According to some embodiments, one or more of computing platform(s) 1802, remote platform(s) 1804, and/or other components of computing system 1800 can be the same as or similar to one or more components of the computing system 10 of FIG. 1, the computing system 300 of FIG. 2, and/or other computing resources disclosed herein.

Computing platform(s) 1802 can be configured by machine-readable instructions 1806. Machine-readable instructions 1806 can include one or more instruction modules. The instruction modules can include computer program modules. The instruction modules can include one or more of Product Search Module 1808, Search Results Module 1810, Results Display Module 1812, Local Navigation Module 1814, In-Store Navigation Module 1816, and/or other instruction modules.

Product Search Module 1808 can be configured to at the computing system 300 or 400. For example, as discussed above, a user may access the mobile application and make a product search request. Search Results Module 1810 can be configured to generate search results for the product search input by the user.

Results Display Module 1812 can be configured to output, to the display, search results to the GUI, the search results being based on the corresponding search request from the user.

Local Navigation Module 1814 can be configured to provide local navigation information, based upon the user-chosen search result. Such local navigation information may include, for example, maps, directions, and/or AR images with markers (e.g. arrows) and/or waypoints shown on an image or video of the local area.

In-Store Navigation Module 1816 can be configured to provide in-store navigation to the corresponding in-store product location corresponding to the user accessing the product search application at the computing system 300 or 400. For example, as discussed above, a user may access the product search feature and make a search request for a local product, select the store, navigate to the store, and then navigate within the store based upon information provided by the In-Store Navigation Module 1816. Such navigation information may include, for example, maps, directions, and/or AR images with markers (e.g. arrows) and/or waypoints shown on an image or video of the in-store layout.

External resources 1826 can include sources of information outside of computing system 1800, external entities participating with computing system 1800, and/or other resources. In some implementations, some or all of the functionality attributed herein to external resources 1826 can be provided by resources included in computing system 1800.

Computing platform(s) 1802 can include electronic storage 1830, one or more processors 1832, and/or other components. Computing platform(s) 1802 can include communication lines, or ports to enable the exchange of information with a network and/or other computing platforms. Illustration of computing platform(s) 1802 in FIG. 18 is not intended to be limiting. Computing platform(s) 1802 can include a plurality of hardware, software, and/or firmware components operating together to provide the functionality attributed herein to computing platform(s) 1802. For example, computing platform(s) 1802 can be implemented by a cloud of computing platforms operating together as computing platform(s) 1802.

Electronic storage 1830 can comprise non-transitory storage media that electronically stores information. The electronic storage media of electronic storage 1830 can include one or both of system storage that is provided integrally (i.e., substantially non-removable) with computing platform(s) 1802 and/or removable storage that is removably connectable to computing platform(s) 1802 via, for example, a port (e.g., a USB port, a firewire port, etc.) or a drive (e.g., a disk drive, etc.). Electronic storage 1830 can include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1830 can include one or more virtual storage resources (e.g., cloud storage, a virtual private network, and/or other virtual storage resources). Electronic storage 1830 can store software algorithms, information determined by processor(s) 1832, information received from computing platform(s) 1802, information received from remote platform(s) 1804, and/or other information that enables computing platform(s) 1002 to function as described herein.

Processor(s) 1832 can be configured to provide information processing capabilities in computing platform(s) 1802. As such, processor(s) 1832 can include one or more of a digital processor, an analog processor, a digital circuit designed to process information, an analog circuit designed to process information, a state machine, and/or other mechanisms for electronically processing information. Although processor(s) 1832 is shown in FIG. 18 as a single entity, this is for illustrative purposes only. In some implementations, processor(s) 1832 can include a plurality of processing units. These processing units can be physically located within the same device, or processor(s) 1832 can represent processing functionality of a plurality of devices operating in coordination. Processor(s) 132 can be configured to execute modules 1808-1816, and/or other modules. Processor(s) 1832 can be configured to execute modules by software; hardware; firmware; some combination of software, hardware, and/or firmware; and/or other mechanisms for configuring processing capabilities on processor(s) 1832. As used herein, the term “module” can refer to any component or set of components that perform the functionality attributed to the module. This can include one or more physical processors during execution of processor readable instructions, the processor readable instructions, circuitry, hardware, storage media, or any other components.

It should be appreciated that although modules 1808-1816 are illustrated in FIG. 8 as being implemented within a single processing unit, in implementations in which processor(s) 1832 includes multiple processing units, one or more of the modules can be implemented remotely from the other modules. The description of the functionality provided by the different modules described herein is for illustrative purposes, and is not intended to be limiting, as any of modules can provide more or less functionality than is described. For example, one or more of modules can be eliminated, and some or all of its functionality can be provided by other ones of modules. As another example, processor(s) 1832 can be configured to execute one or more additional modules that can perform some or all of the functionality attributed below to one of modules 1808-1816.

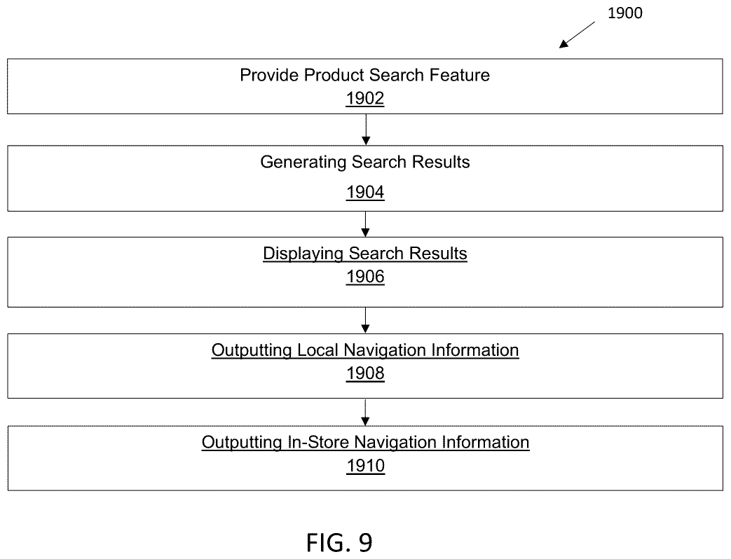

FIG. 9 is a flow chart showing functions of a method for locating and providing detailed navigation to products at local retailers, in accordance with the example embodiments. FIG. 9 is a flow chart showing a set 1900 of functions of that can be carried out using the computing system 10 of FIG. 1, the computing system 300 shown in FIG. 2, the computing system 1800 of FIG. 8, the computing platform(s) 1802, the remote platform(s) 1804, and/or other computing resources. A method of the example embodiments can include one or more functions of the set 1900 and/or a portion of one or more functions of the set 1900. Additionally, the order in which the functions of set 1900 are illustrated in FIG. 19 and described below is not intended to be limiting.

Accordingly, a method based on function(s) of the set 1900 can include a computer-implemented method involving a software application executed by the computing system (e.g., computing system 10 of FIG. 1), the computing system 1800 of FIG. 8, the computing platform(s) 1802, the remote platform(s) 1804, and/or other computing resources) with and/or in communication with a display screen. The software application involves graphically displaying a user interface that may include information, selectable features, updates etc.

FIG. 9 illustrates set 1900. Block 1902 includes providing a product search feature. The functions of block 1902 can be performed by one or more hardware processors configured by machine-readable instructions including a product search module 1808, in accordance with the example embodiments.

Block 1904 includes generating search results corresponding to a user accessing the product search feature of the mobile application at the computing system. The functions of block 1904 can be performed by one or more hardware processors configured by machine-readable instructions including a module that is the same as or similar to Search Results Module 1810, in accordance with the example embodiments.

Block 1906 includes outputting, to the display, the search results. The functions of block 1906 can be performed by one or more hardware processors configured by machine-readable instructions including a module that is the same as or similar to Results Display Module 1812, in accordance with the example embodiments.

Block 1908 includes outputting, to the display, local navigation information, based a user's selection, including step-by-step instructions and/or a route map to the selected store. The functions of block 1908 can be performed by one or more hardware processors configured by machine-readable instructions including a module that is the same as or similar to Local Navigation Module 1814, in accordance with the example embodiments.

Block 1910 includes outputting, to the display, in-store navigation information. Such navigation information may include, for example, maps, directions, and/or AR images with markers (e.g. arrows) and/or waypoints shown on an image or video of the in-store layout. The functions of block 1910 can be performed by one or more hardware processors configured by machine-readable instructions including a module that is the same as or similar to In-Store Navigation Module 1816, in accordance with the example embodiments.

Some of the illustrative aspects of the present invention may be advantageous in solving the problems herein described and other problems not discussed which are discoverable by a skilled artisan.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

Users may download an application on their mobile phones, tablets or any other mobile computing device, and even a vehicle.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

As may also be used herein, the terms “processor”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

The embodiments of the invention described herein are exemplary and numerous modifications, variations and rearrangements can be readily envisioned to achieve substantially equivalent results, all of which are intended to be embraced within the spirit and scope of the invention. Further, the purpose of any included abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A computer system to locate and provide detailed navigation to products at local retailers, the system comprising:
one or more hardware processors and associated memory configured by machine-readable instructions to:
provide a product search feature configured to be accessed by a user;
generate product search results, based upon a user product search request input to the product search feature, including an availability, inventory, price and store location, of a searched product;
output the search results to a visual display for selection by the user;
output to the visual display, based upon a chosen result of the product search results selected by the user, navigation information providing local navigation to the corresponding store location; and
output to the visual display, based upon the chosen result, in-store location identifying details providing in-store navigation to the corresponding in-store product location.

2. The computing system of claim 1, wherein providing the product search feature includes outputting a graphical user interface (GUI), including a product search field.

3. The computing system of claim 1, wherein providing the product search feature comprises providing a voice-activated product search feature.

4. The computing system of claim 1, wherein the user product search request input to the product search feature includes at least one of keywords, barcodes, and QR codes.

5. The computing system of claim 1, wherein the visual display comprises at least one of a visual display unit, Augmented Reality (AR) smart glasses, and an image projector.

6. The computing system of claim 1, wherein the navigation information includes at least one of turn-by-turn directions and map guidance to guide the user to the corresponding store location.

7. The computing system of claim 1, wherein the in-store location identifying details includes at least one of waypoints, turn-by-turn directions, and an interactive store map.

8. A method to locate and provide detailed navigation to products at local retailers, using one or more hardware processors and associated memory configured by machine-readable instructions, the method comprising:
providing a product search feature configured to be accessed by a user;
generating product search results, based upon a user product search request input to the product search feature, including an availability, inventory, price and store location, of a searched product;
outputting the search results to a visual display for selection by the user;
outputting to the visual display, based upon a chosen result of the product search results selected by the user, navigation information providing local navigation to the corresponding store location; and
outputting to the visual display, based upon the chosen result, in-store location identifying details providing in-store navigation to the corresponding in-store product location.

9. The method of claim 8, wherein providing the product search feature includes outputting a graphical user interface (GUI), including a product search field.

10. The method of claim 8, wherein providing the product search feature comprises providing a voice-activated product search feature.

11. The method of claim 8, wherein the user product search request input to the product search feature includes at least one of keywords, barcodes, and QR codes.

12. The method of claim 8, wherein the visual display comprises at least one of a visual display unit, Augmented Reality (AR) smart glasses, and an image projector.

13. The method of claim 8, wherein the navigation information includes at least one of turn-by-turn directions and map guidance to guide the user to the corresponding store location.

14. The method of claim 8, wherein the in-store location identifying details includes at least one of waypoints, turn-by-turn directions, and an interactive store map.

15. A computer-readable memory having stored therein instructions executable by a processor to cause a computing system to perform functions comprising:
providing a product search feature configured to be accessed by a user;
generating product search results, based upon a user product search request input to the product search feature, including an availability, inventory, price and store location, of a searched product;
outputting the search results to a visual display for selection by the user;
outputting to the visual display, based upon a chosen result of the product search results selected by the user, navigation information providing local navigation to the corresponding store location; and
outputting to the visual display, based upon the chosen result, in-store location identifying details providing in-store navigation to the corresponding in-store product location.

16. The computer-readable memory of claim 15, wherein providing the product search feature includes outputting a graphical user interface (GUI), including a product search field.

17. The computer-readable memory of claim 15, wherein providing the product search feature comprises providing a voice-activated product search feature.

18. The computer-readable memory of claim 15, wherein the visual display comprises at least one of a visual display unit, Augmented Reality (AR) smart glasses, and an image projector.

19. The computer-readable memory of claim 15, wherein the navigation information includes at least one of turn-by-turn directions and map guidance to guide the user to the corresponding store location.

20. The computer-readable memory of claim 15, wherein the in-store location identifying details includes at least one of waypoints, turn-by-turn directions, and an interactive store map.
